(19) United States
(12) Patent Application Publication
(10) Pub. No.: US 2017/0114810 A1
(43) Pub. Date: Apr. 27, 2017

(54) METHOD FOR PRODUCING A BONDED JOINT, AND STRUCTURAL ELEMENT

(71) Applicant: RHEINISCH WESTFÄLISCHE TECHNISCHE HOCHSCHULE AACHEN (RWTH), Aachen (DE)

(72) Inventors: Matthias ANGERHAUSEN, Aachen (DE); Uwe REISGEN, Eschweiler (DE)

(73) Assignee: RHEINISCH WESTFÄLISCHE TECHNISCHE HOCHSCHULE AACHEN (RWTH), Aachen (DE)

(21) Appl. No.: 15/301,524

(22) PCT Filed: Apr. 1, 2015
(86) PCT No.: PCT/DE2015/100141

§ 371 Date: Oct. 3, 2016

(30) Foreign Application Priority Data
Apr. 2, 2014 (DE) 10 2014 104 711.7

(51) Int. Cl. F16B 5/08; B23K 9/173

(52) U.S. Cl. CPC F16B 5/08; B23K 9/173; B23K 2201/006

(57) ABSTRACT

A method for producing a bonded joint between a light metal of a first component and a steel material of a second component, wherein a protective-gas joining process is used, a zinc-based filler material is used, and wherein an arc of the protective-gas joining process reaches at least the steel material of the second component, wherein a phase space of at least intermetallic phase composed of iron and the light metal is produced in a joining region adjacent to the steel material. Introduction of heat occurs so that the joint to the steel material is a solder or brazed connection and, during joining, a detachment of part of the solidified intermetallic phase(s) from the steel material of the second component starts in a melt of a solder or brazed matrix formed by the filler material and the at least one intermetallic phase is embedded in the solder matrix.

The invention relates to a method for producing an integral joint between a first component composed of a light metal and a second component composed of a steel material and also to a structural element according to the preamble of claim 6.

Welded/soldered connections between a light metal and a steel material are of interest in particular in motor vehicle construction. The light metal is used for reducing weight, while steel materials are still required in regions of a vehicle body which are particularly relevant to stability.

A method and also a structural element of the type mentioned in the introduction are known from DE 10 2011 012 939 A1, according to which a component composed of a steel material is joined to a component composed of an aluminum alloy. In this case, use is made of a welded/soldered connection in which the aluminum component is heated to a temperature above its melting point in the joining region and is then brought into contact with the component composed of steel. An integral soldered connection is formed between the steel material and the aluminum. It is furthermore disclosed to carry out a cold metal transfer welding process as the joining process. Moreover, it is proposed to galvanize the steel material component before the joining process in order to provide a corrosion-resistant connection.

EP 1 806 200 A1 discloses a method for integrally joining an aluminum component to a steel component, in which a zinc layer is formed on the connection side of the aluminum component and/or of the steel component and the two components are arranged so as to overlap with the zinc layer located therebetween. Resistance welding, laser welding, electron beam welding or arc welding can then be used as the joining process, for example. The zinc enters into a welded connection with the aluminum, whereas the steel component forms a soldered connection with the zinc.

Thermal joining between a component composed of aluminum or an aluminum alloy and a steel component generally leads to the formation of a phase seam comprising one or more intermetallic phases which are composed of various chemical compounds of iron and aluminum. The intermetallic phases, which arise at the interface with the steel component even without a weld pool produced in the steel material, i.e. in the case of soldered connections, have a brittle behavior owing to their hardness and low tensile strength, and can thereby impair the mechanical properties of the connection. On account of this, the prior art strives to suppress the formation of the intermetallic phase(s) as far as possible by introducing as little heat as possible into the steel material during the joining process. For this purpose, when using shielding gas welding processes, the prior art strives not to allow the arc to come into contact with the component composed of steel material as far as possible, as a result of which a narrow process window is provided particularly with respect to the torch guidance and the introduction of energy.

In the literature, a value of 10 μm is mentioned in most cases as a still tolerable maximum thickness of the phase seam. If this value is exceeded, brittle failure may occur even when the joints are subjected to low mechanical loading. Accordingly, the size of the intermetallic phase seam which forms is crucial for the mechanical-technological properties of the joint produced between steel and light metal. Since at the same time it has only been possible to date to control the formation of the intermetallic phases with difficulty, the thermal joining of steel material and aluminum material is not yet used in industrial production. The thickness of the phase seam can only be determined by destructive testing methods, and this makes industrial quality assurance more complicated.

US 2011/0020666 A1 discloses a method for connecting a first component composed of a light metal, in particular aluminum, and a second component composed of an iron-based material with the involvement of a zinc-based filler material according to the preamble of claim 1 and also a structural element according to the preamble of claim 6. Firstly, in variants designated therein as first to third embodiments, it is disclosed to heat the iron-based component to a temperature above its melting point in order to increase the strength of connection between the iron-based component and the connecting layer. In embodiments in which the zinc-based filler material does not contain any silicon, it is said that an intermetallic connecting layer in the form of an Al—Fe—Zn system should form at the transition between the iron-based component and the connecting layer comprising the zinc-based filler material. The layer of the intermetallic connecting layer has a high ductility, and therefore the strength of connection between the iron-based component and the connecting layer can be increased. In the exemplary embodiments illustrated, the intermetallic connecting layer, which remains largely compact, in each case directly adjoins the iron-based component. The intermetallic connecting layer therefore continues to have a considerable influence on the quality of the joint.

In the aforementioned US document, a possible filler material proposed in the second to fourth embodiments is a Zn—Si-based metal, in the case of which no intermetallic connecting layer is said to form. In the fourth embodiment, neither the iron-based component nor the aluminum-based component is melted. This clearly avoids subjecting the iron-based component to the laser radiation. In this case, too, a uniform intermetallic connecting layer is formed between the iron-based component and the connecting layer provided between the components. However, as soon as silicon is used as additive in the zinc-based filler material, an intermetallic connecting layer of this type does not form.

For the introduction of energy, US 2011/0020666 A1 discloses the use of laser radiation. It is only in relation to the second embodiment using a zinc-based filler material comprising silicon, in which no intermetallic connecting layer is formed, that TIG or MIG methods, inter alia, are proposed as alternatives to the use of laser radiation.

It is therefore an object of the present invention to provide a method of the type mentioned in the introduction which makes it possible to achieve an increased reliability of the joint. It is a further object to provide a structural element of the type mentioned in the introduction which has a reliable joint.

With respect to the method, this object is achieved by the characterizing features of claim 1. Advantageous embodiments of the method become apparent from dependent claims 2 to 5.

It has surprisingly been found that, given a high level of heat introduction into the component composed of steel material during the shielding gas joining process, the phase seam breaks up and is penetrated by the molten zinc melt or zinc-containing melt of the filler material. Therefore, the arc also has to be directed onto the steel material. It is even advantageous if the surface of attack of the arc is provided predominantly on the steel material. Nevertheless, a pure soldered or brazed connection should be formed with the steel material, whereas, in the case of the prior art specified in US 2011/0020666 A1, various exemplary embodiments each provide that a welded connection is produced between the filler material and the Fe-based component, since melting is effected on the Fe-based component according to the teaching therein. In the case of a fourth embodiment disclosed in US 2011/0020666 A1, although the joining process is effected without melting of the iron-based component, in this case the laser beam is clearly not directed onto the Fe-based component.

In this case, the heat introduction is effected in such a manner that the brittle intermetallic phase(s) is or are incorporated in a ductile matrix consisting at least predominantly of zinc, this being referred to hereinbelow as solder or brazed matrix. The cracks which often arise in the intermetallic phase during thermal joining processes are avoided or contained by a ductile matrix melt and can be closed. This gives rise to a drastic reduction in the impairment caused by the intermetallic phase(s) on the strength of the joint. At the same time, the process window is increased considerably compared to the prior art, and this ensures a high degree of reproducibility. In contrast to in the case of diverse methods in the prior art, the arc may and should act directly on the steel material of the second component according to the method according to the invention. The torch therefore no longer has to be guided precisely on the edge of the light metal component—as is customary in the prior art and generally also problematic—in order to avoid contact between the arc and the steel material. In addition, in order to avoid the formation of intermetallic phases to the greatest possible extent, in the prior art the quantity of the energy introduced into the process zone was limited as far as possible, and this is no longer necessary with the method according to the invention. The method according to the invention therefore allows for an increased leeway for the electrical currents and voltages used in the joining process. It is therefore possible for the method to be used for mass production. It is possible to dispense with the determination of the thickness of the intermetallic phase seam by destructive tests, and this also makes it possible to use the thermal joining of components composed of steel material and a light metal in industrial production.

With the zinc-based filler material, it is possible to dispense with a zinc coating of the steel material. However, the method according to the invention can also be used in the case of a joint with a component composed of galvanized steel material, which can promote the wetting properties of the melt on the steel material.

For the joining process, it is possible to employ shielding gas welding processes such as, for example, MAG or MIG, in particular low-energy short-arc processes. The filler material originates from the wire electrode of the method. In spite of the fact that this is designated as a welding method, a welded joint does not have to be formed. A soldered or brazed connection is always provided at the boundary with the steel material. The light metal can enter into a welded connection but alternatively also a soldered or brazed connection with the solder or brazing material. A welded/soldered/brazed connection is often desired.

The method according to the invention is carried out in such a way that the introduction of heat is effected in such a manner that, during the joining process, a detachment of at least part of the solidified intermetallic phase(s) from the steel material of the second component starts. The detachment is effected in a melt of a solder or brazed matrix formed with the filler material. This leads not only to breaking up of the intermetallic phase(s) but also to detachment from the steel material, such that the intermetallic phase(s) can be infiltrated at least in part by the matrix material of the solder matrix, as a result of which the mechanical properties of the joint are improved further. The detachment process can also be effected repeatedly. It is thus possible, after detachment of a first layer of one or more solidified intermetallic phases, for a further layer of intermetallic phase(s) to form, this then being detached in turn in solidified form and being infiltrated by the zinc melt.

In addition, it has been determined that the intermetallic phase can be distributed in increasingly small structures within the solder matrix, and this results in a further improved tensile strength of the connection. The structure of the distribution of the intermetallic phase in the solder or brazed matrix presumably depends on the duration of the existence of the weld pool composed of the filler material and if appropriate of the light metal material of the first component. With an increasing duration, the intermetallic phase has more time to break up and be distributed in the solder matrix, e.g. on account of a weld pool movement and/or through diffusion processes. The duration of the existence of the weld pool at a specific location of the joint can be influenced, for example, by the joining process parameters, for example joining speed, current and voltage values.

A significant factor for the tearing up and detachment of the intermetallic phase(s) is the difference in the coefficients of expansion of the steel material on the one hand and of the intermetallic phase(s) on the other hand.

The light metal is preferably aluminum or an aluminum alloy. Other light metals, such as for example magnesium, are likewise conceivable.

It may be advantageous if the zinc-based filler material comprises aluminum. By way of example, it is possible to use ZnAl4, ZnAl15 or ZnAl5Cu3.5.

Furthermore, the method according to the invention can be carried out in such a way that the second component is heated by means of an additional heat source, e.g. with a resistance heating system or by means of induction heating. The coefficient of expansion of the steel material is generally considerably higher than that of the brittle intermetallic phase(s). This difference has a greater effect with an increasing temperature of the second component composed of steel material, which is why the additional heating of the second component is advantageous. Heating by means of an additional heat source can also prevent the heat introduced into the join by the joining process from being distributed too quickly in the second component and removed from the joining region.

In particular, the method according to the invention can be carried out in such a way that the heat is supplied from a side of the second component which is faced away from the joining process.

With respect to a structural element of the type mentioned in the introduction, the aforementioned object is achieved by the characterizing features of claim 6. Advantageous embodiments become apparent from dependent claims 7 and 8.

With the intermetallic phase(s) embedded in the solder or brazed matrix, the mechanical and technological properties of the structural element are improved. Cracks which possibly form in the intermetallic phase are contained by the solder or brazing material, which is zinc or predominantly zinc, and ideally filled. During the joining process, the still molten solder or brazing material flows into the fissures which form in the intermetallic phase(s) and thereby penetrates the intermetallic phase(s). The structural element is preferably produced using the above-described method according to the invention.

It is advantageous if, at least in a partial region of a joining surface of the second component which is covered with the soldered or brazed connection, a proportion of the solder or brazed matrix forms at least one cohesive separating layer, which is arranged between the steel material and at least a predominant proportion of the intermetallic phase(s) located above the partial region of the joining surface. This separating layer is formed during the joining process as a result of the detachment of at least part of the intermetallic phase(s) from the steel material, e.g. on account of the different expansion behavior of intermetallic phase and steel material, and as a result of the infiltration of the detached part by the still molten solder or brazing material.

The separating layer is located directly on the steel material or else so close thereto that the thickness of the intermetallic phase(s) is greater on that side of the separating layer which is remote from the steel material than between separating layer and steel material. The predominant part of the intermetallic phase(s) is therefore detached from the steel material of the second component.

It may also be advantageous if the intermetallic phase(s) is (are) divided into at least two layers, between which in each case there is an intermediate layer in turn consisting predominantly of the material of the solder or brazed matrix. In this way, the solder or brazed matrix can contain the microcracks which arise in the intermetallic phase(s) in a particularly efficient manner and ideally close them.

The text which follows explains a preferred embodiment of the method according to the invention and also a structural element with reference to figures.

FIG. 1: shows the use of an arc process on two components to be joined to one another,

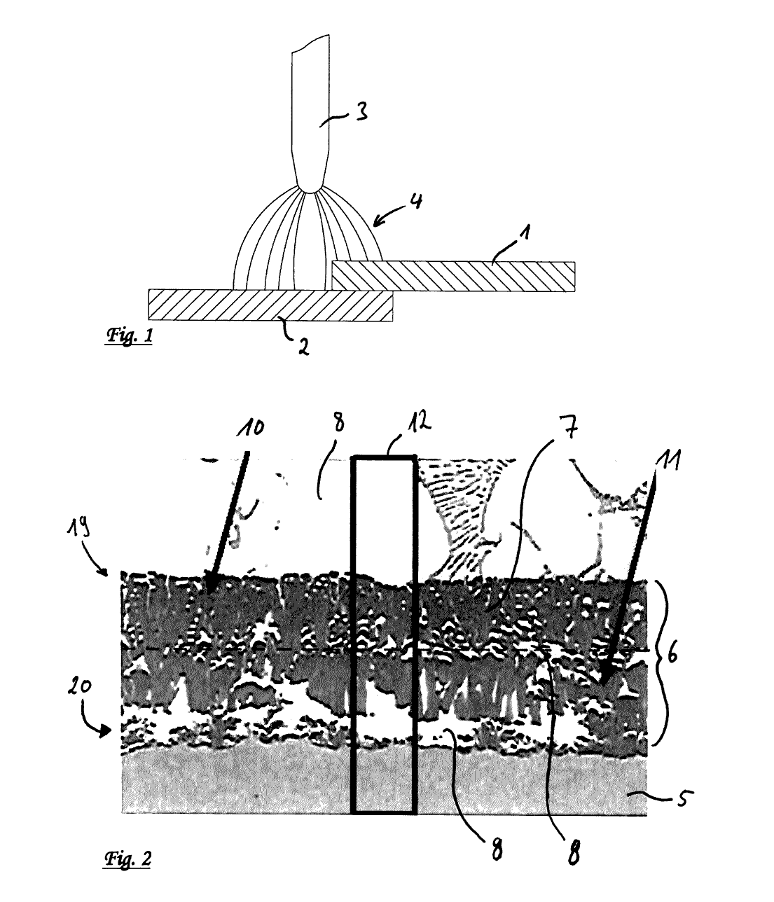

FIG. 2: shows a microscope micrograph of the joint with phase seam,

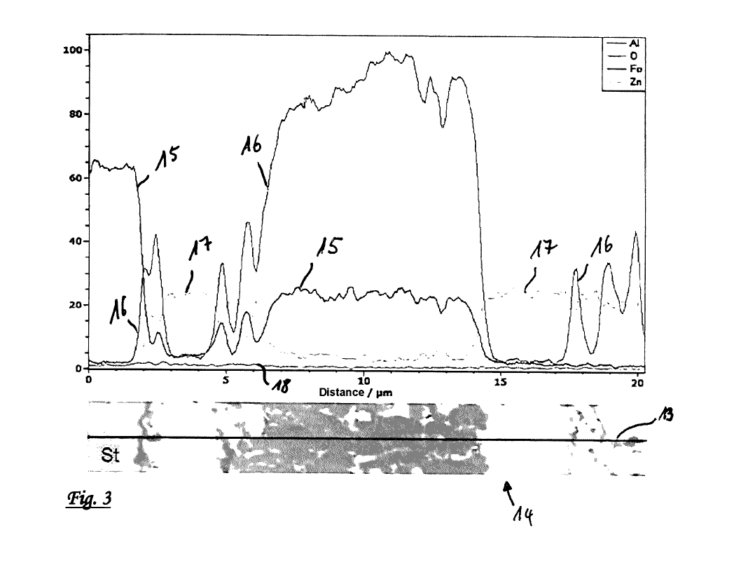

FIG. 3: shows a diagram relating to the composition of the joint in the region of the phase seam, and

FIG. 4: shows a further microscope micrograph of a further joint with phase seam.

FIG. 1 schematically shows the use of an arc process for producing an integral joint between a first component 1 composed of aluminum and a second component 2 composed of a steel material. A wire electrode 3 serves for producing an arc 4, which impinges with its surface of attack predominantly on the second component 2 composed of steel material. The wire electrode 3 is zinc-based and may contain aluminum as a further constituent, for example. Additional alloying constituents may be magnesium and/or copper, for example.

FIG. 2 shows a microscopic microsection 19 from a region of a soldered or brazed connection of a structural element produced by the method according to the invention. A steel material layer 5 of the second component 2 can be seen right at the bottom in the microsection 19. Above the steel material layer 5, a phase seam 6 having a thickness of approximately 20 μm and comprising intermetallic phases 7 (here shown as a dark color) has formed. Adjoining above the phase seam 6 is a layer composed of a solder or brazed matrix 8, which consists at least essentially of the solder or brazing material of the wire electrode 3, specifically at least predominantly of zinc. The phase seam 6 is penetrated by the solder or brazed matrix 8 shown as a light color in the microsection 19. The already solidified intermetallic phase 7 became detached from the steel base material 5 during the joining process and was thus able to be infiltrated by the material of the solder or brazed matrix 8. The reason for the detachment is the different expansion behavior of intermetallic phase 7 and the steel material during the targeted introduction of heat into the second component 2. The infiltration created a separating layer 20, which is formed by the material of the solder or brazed matrix 8 and, after it has solidified, ensures at least in certain regions that there is a permanent separation of the steel material layer 5 from at least a predominant proportion of the intermetallic phase(s) 7. Fissures in the intermetallic phase(s) 7 have moreover had the effect that the intermetallic phase(s) has or have been not only infiltrated but also penetrated by the material of the solder or brazed matrix 8.

In the microsection 19 shown in FIG. 2, an increased proportion of the solder or brazed matrix 8 can be seen in the phase seam 6 approximately in the center (see the dashed line). This makes it possible to conclude that a first phase region 10 of the phase seam 6 (above the dashed line) was first formed and then detached and infiltrated by the material of the solder or brazed matrix 8, before a second phase region 11 of the phase seam 6 (below the dashed line) was formed and in turn detached and likewise infiltrated by the material of the solder or brazed matrix 8, now forming the separating layer 20.

The rectangle 12 shown upright in FIG. 2 symbolically represents a sample of the structural element which was examined with respect to the composition thereof.

FIG. 3, below a diagram, likewise shows with a microsection a sample 14 of another structural element. A concentration profile was measured on the sample 14 along a centrally running measurement line 13 by means of an energy-dispersive X-ray microanalysis. The diagram shows an Fe graph 15 for the iron content, an Al graph 16 for the aluminum content, a Zn graph 17 for the zinc content and also (less significant here) an O graph 18 for the oxygen content. It can clearly be seen that, in the case of a path shown along the abscissa of the diagram, the aluminum content increases briefly from approximately 2 μm in an albeit very narrow region, but then levels off considerably, such that between approximately 3 μm and approximately 4.5 μm the zinc is predominant. Only from approximately 5 μm to approximately 14.5 μm is a region dominated substantially by the intermetallic phase composed of iron and aluminum, with the penetration with zinc also being clearly identifiable from the microsection of the sample region 14. A region which is clearly dominated by the zinc is identifiable in turn above the phase seam, from approximately 14.5 μm, before an increased aluminum proportion becomes visible, which can originate from the wire electrode 3 or else from the molten aluminum material of the first component 1.

FIG. 4 shows a further microscope micrograph, which verifies that the intermetallic phase 7 forms very fine-grained structures which are shown here as a lighter color and which are distributed in the surrounding zinc-based solder matrix 8 shown as a darker color. With an increasingly fine-grained structure, the influence of the intermetallic phase 7 on the strength of the soldered connection between the solder or brazed matrix 8 and the steel material layer 5 is reduced further.

### LIST OF REFERENCE SIGNS

1 First component

2 Second component

3 Wire electrode

4 Arc

5 Steel material layer

6 Phase seam

7 Intermetallic phase

8 Solder or brazed matrix

10 First phase region

11 Second phase region

12 Rectangle

13 Measurement line

14 Sample

15 Fe graph

16 Al graph

17 Zn graph

18 O graph

19 Microsection

20 Separating layer

1-8. (canceled)

9. A method for producing an integral joint between a light metal of a first component and a steel material of a second component, comprising:
a shielding gas joining process utilizing a zinc-based filler material is used, and an arc of the shielding gas joining process reaches at least also the steel material of the second component, wherein a phase seam comprising at least one intermetallic phase comprised of iron and the light metal is produced in a joining region adjoining the steel material,
wherein the introduction of heat is effected in such a manner that the joint to the steel material is a soldered or brazed connection and, during the joining process, a detachment of at least part of the solidified intermetallic phase(s) from the steel material of the second component starts in a melt of a solder or brazed matrix formed with the filler material, and the at least one intermetallic phase is embedded in the solder or brazed matrix.

10. The method as claimed in claim 9, wherein the first component comprises aluminum or an aluminum alloy at least in the joining region.

11. The method as claimed in claim 9, wherein the zinc-based filler material comprises aluminum.

12. The method as claimed in claim 9, wherein the second component is heated by means of an additional heat source.

13. The method as claimed in claim 12, wherein the heat is supplied from a side of the second component which faces away from the joining process.

14. A structural element, comprising:
a first component comprising a light metal and a second component, which comprises a steel material and is integrally joined to the first component with the involvement of a zinc-based filler material, wherein the joint to the steel material of the second component is provided by a soldered or brazed connection, which has a phase seam comprising at least one intermetallic phase composed of iron and the light metal, wherein,
in the phase seam of the hardened soldered or brazed connection, the intermetallic phase(s) is or are embedded in an at least predominantly zinc-comprising solder or brazed matrix.

15. The structural element as claimed in claim 14, wherein, at least in a partial region of the joining surface of the second component which is covered with the soldered or brazed connection, a proportion of the solder or brazed matrix forms at least one cohesive separating layer, which is arranged between the steel material of the second component and at least a predominant proportion of the intermetallic phase(s) located above the partial region of the joining surface.

16. The structural element as claimed in claim 15, wherein the partial region comprising the at least one separating layer is larger than 50% of the joining surface covered with the soldered or brazed connection.
